(19) United States
(12) Patent Application Publication
(10) Pub. No.: US 2020/0341317 A1
(43) Pub. Date: Oct. 29, 2020

(54) LIQUID CRYSTAL DISPLAY AND MANUFACTURING METHOD THEREOF

(71) Applicant: Samsung Display Co., Ltd., Yongin-Si (KR)

(72) Inventors: Hwan Young JANG, Hwaseong-si (KR); Min Kyu JI, Cheonan-si (KR)

(21) Appl. No.: 16/733,265

(22) Filed: Jan. 3, 2020

(30) Foreign Application Priority Data
Apr. 25, 2019 (KR) 10-2019-0048348

(51) Int. Cl. G02F 1/1339; G02F 1/1333; G02F 1/1341

(52) U.S. Cl. CPC G02F 1/13394; G02F 2001/13396; G02F 1/1341; G02F 1/133345

(57) ABSTRACT

The present inventive concept relates to a liquid crystal display and a manufacturing method thereof. The liquid crystal display includes: a first display panel, a second display panel, and a sealant and a liquid crystal layer disposed therebetween and a protrusion disposed on the first display panel, disposed between a display area and the sealant, and protruding toward the second display panel, wherein the first display panel includes a first substrate, the protrusion includes a peak where an upper surface of the protrusion is the highest with respect to an upper surface of the first substrate, a first portion disposed between the peak and the sealant, and a second portion disposed between the peak and the display area, and an inclination of the upper surface of the first portion is gentler than an inclination of the upper surface of the second portion in a cross-sectional view.

### CROSS-REFERENCE TO RELATED APPLICATION

This application claims priority to and the benefit of Korean Patent Application No. 10-2019-0048348 filed in the Korean Intellectual Property Office on Apr. 25, 2019, the entire contents of which are incorporated herein by reference.

### BACKGROUND

### (a) Technical Field

The present disclosure relates to a liquid crystal display and a manufacturing method thereof.

### (b) Description of the Related Art

A liquid crystal display is one of flat panel displays and it includes two display panels on which field generating electrodes such as a pixel electrode and a common electrode are formed and a liquid crystal layer provided therebetween. The liquid crystal display applies a voltage between the field generating electrodes to generate an electric field to the liquid crystal layer, determines an alignment of liquid crystal molecules of the liquid crystal layer, and controls polarization of incident light to thus display images.

On one of the two display panels configuring the liquid crystal display, a gate line for transmitting a gate signal, a data line for transmitting a data signal, a thin film transistor connected to the gate line and the data line, and a pixel electrode connected to the thin film transistor may be provided. On the other display panel, a light blocking member, a color filter, and a common electrode may be provided. The light blocking member, the color filter, and the common electrode may be provided on the display panel on which the thin film transistor is formed.

A method for dripping liquid crystal may be used so as to form the liquid crystal layer of the liquid crystal display. For example, a sealant is formed on one of the two display panels to define an active area, and liquid crystal is dispensed on the display panel on which the sealant is formed at regular intervals according to a one drop filling scheme. The two display panels are arranged and bonded to each other, and the sealant may be cured under vacuum.

The above information disclosed in this Background section is only for enhancement of understanding of the background of the inventive concept and therefore it may contain information that does not form the prior art that is already known in this country to a person of ordinary skill in the art.

### SUMMARY

The present inventive concept has been made in an effort to fill liquid crystal in a corner portion from among an active area in which a liquid crystal layer of a liquid crystal display is provided.

An exemplary embodiment of the present inventive concept provides a liquid crystal display including: a first display panel and a second display panel including a display area for displaying an image and a peripheral area surrounding the display area in a plan view; a sealant disposed between the first display panel and the second display panel and having a shape of a closed loop surrounding the display area in the plan view; a liquid crystal layer disposed between the first display panel and the second display panel and including liquid crystal molecules; and a protrusion disposed on the first display panel, disposed between the display area and the sealant in the plan view, and protruding toward the second display panel, wherein the first display panel includes a first substrate, and the protrusion includes a peak where the protrusion has a highest height with respect to an upper surface of the first substrate, a first portion disposed between the peak and the sealant, and a second portion disposed between the peak and the display area, wherein an inclination angle of the upper surface of the first portion is less than an inclination angle of the upper surface of the second portion in a cross-sectional view.

A distance to the peak from an edge of the protrusion which is disposed adjacent to the sealant is longer than a distance to the peak from an edge of the protrusion which is disposed away from the sealant.

An active area may be defined as an area surrounded by the sealant, and the active area may include a corner area disposed between a corner of the active area and a corner of the display area facing each other in the plan view, and the protrusion may include a portion disposed in the corner area.

The display area may include a first corner adjacent to the corner area and two edges of the display area meet at the first corner, and the protrusion may further include a portion disposed between one of the two edges of the display area and the sealant.

The protrusion may have a shape of a closed loop disposed between an edge of the display area and the sealant.

The liquid crystal display may further include at least one of a light blocking layer, a color filter, or a passivation layer disposed in the display area, wherein the passivation layer may include an organic insulating material, and the protrusion may be disposed on a same layer and include a same material as at least one of the light blocking layer, the color filter, or the passivation layer.

The protrusion may include a first protrusion and a second protrusion, the first protrusion may overlap the second protrusion in a vertical direction to an upper surface of the first substrate, and a thickness of the first protrusion and a thickness of the second protrusion gradually decrease as a distance from the sealant decreases.

The protrusion may be divided into a plurality of separated portions with at least one gap disposed between adjacent separated portions in the plan view.

An active area may be defined as an area surrounded by the sealant, and the active area may include a corner area disposed between a corner of the active area and a corner of the display area in the plan view, and the at least one gap may be disposed in the corner area.

The gap may extend toward the sealant from the corner of the display area in the plan view.

Another embodiment of the present inventive concept provides a liquid crystal display including: a first display panel and a second display panel including a display area for displaying an image and a peripheral area surrounding the display area in a plan view; a sealant disposed between the first display panel and the second display panel and having a shape of a closed loop surrounding the display area in the plan view; a liquid crystal layer liquid including crystal molecules disposed between the first display panel and the second display panel; and a protrusion disposed on the first display panel, disposed between the display area and the sealant in the plan view, and protruding toward the second display panel, wherein the first display panel may include a first substrate, the protrusion may include a first portion and a second portion which have upper surfaces with different heights from each other with respect to an upper surface of the first substrate, a height of an upper surface of the first portion with respect to the upper surface of the first substrate may be less than a height of an upper surface of the second portion, and the first portion may be disposed closer to the sealant than the second portion and the first portion may be connected to the second portion.

The protrusion may further include a third portion disposed between the first portion and the second portion, and a thickness of the third portion with respect to the upper surface of the first substrate gradually decreases as a distance from the sealant decreases.

An active area may be defined as an area surrounded by the sealant, and the active area may include a corner area disposed between a corner of the active area and a corner of the display area facing each other in a plan view, and the protrusion may include a portion disposed in the corner area.

The display area may include a first corner adjacent to the corner area, and two edges of the display area meet at the first corner, and the protrusion may further include a portion disposed between one of the two edges of the display area and the sealant.

The protrusion may have a shape of a closed loop disposed between an edge of the display area and the sealant.

The liquid crystal display may further include at least one of a light blocking layer, a color filter, or a passivation layer disposed in the display area, wherein the passivation layer may include an organic insulating material, and the protrusion may be disposed in a same layer and include a same material as at least one of the light blocking layer, the color filter, or the passivation layer.

The protrusion may include a first protrusion and a second protrusion, the first protrusion may overlap the second protrusion in a vertical direction to the upper surface of the first substrate, and a thickness of the first protrusion and a thickness of the second protrusion with respect to the upper surface of the first substrate gradually decrease as a distance from the sealant decreases.

Yet another embodiment of the present inventive concept provides a method of manufacturing a liquid crystal display, including: forming a first display panel and a second display panel including a display area and a peripheral area surrounding the display area; forming a sealant on one of the first display panel and the second display panel; dispensing a liquid crystal material including liquid crystal molecules to one of the first display panel and the second display panel; and arranging and bonding the first display panel and second display panel with each other, and hardening the sealant, wherein the forming of the first display panel may include forming a protrusion disposed between the display area and the sealant and protruding toward the second display panel by using a photo-mask, and a transmittance of the photo-mask gradually increases as a distance from the sealant decreases.

The photo-mask may include a light blocking portion and a light transmitting portion, the light transmitting portion may have a slit shape, and the light transmitting portion and the light blocking portion may be alternately arranged.

Widths of the light blocking portion and the light transmitting portion may be equal to or less than a resolution of a light exposer.

According to the exemplary embodiments of the present inventive concept, stains may be prevented from being generated by sufficiently filling liquid crystal in the corner portion from among the active area in which the liquid crystal layer of the liquid crystal display is provided.

### BRIEF DESCRIPTION OF THE DRAWINGS

FIG. 1 shows a top plan view of a liquid crystal display according to an exemplary embodiment of the present inventive concept.

FIG. 2 and FIG. 3 show cross-sectional views of a liquid crystal display shown in FIG. 1 with respect to a line IIa-IIb.

FIG. 4 and FIG. 5 show top plan views of a liquid crystal display according to an exemplary embodiment of the present inventive concept.

FIG. 6 shows a top plan view of one pixel of a liquid crystal display according to an exemplary embodiment of the present inventive concept.

FIG. 7 shows a cross-sectional view of a liquid crystal display shown in FIG. 6 with respect to a line VIIa-VIIb.

FIG. 8, FIG. 9, FIG. 10, FIG. 11, FIG. 12, FIG. 13, FIG. 14, and FIG. 15 show cross-sectional views of a liquid crystal display shown in FIG. 1 with respect to a line IIa-IIb.

FIG. 16, FIG. 17, and FIG. 18 show top plan views of a liquid crystal display according to an exemplary embodiment of the present inventive concept.

FIG. 19, FIG. 20, FIG. 21, and FIG. 22 show top plan views of a photo-mask used in one process in a method for manufacturing a liquid crystal display shown in FIG. 1 according to an exemplary embodiment.

FIG. 23 shows a flowchart of a predetermined process in a method for manufacturing a liquid crystal display according to an exemplary embodiment of the present inventive concept.

### DETAILED DESCRIPTION OF THE EMBODIMENTS

The present inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the present inventive concept.

The drawings and description are to be regarded as illustrative in nature and not restrictive, and like reference numerals designate like elements throughout the specification.

The size and thickness of each configuration shown in the drawings are arbitrarily shown for better understanding and ease of description, and the present inventive concept is not limited thereto. In the drawings, the thickness of layers, films, panels, regions, etc., are exaggerated for clarity. For better understanding and ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” means positioned on or below the object portion, and does not necessarily mean positioned on the upper side of the object portion based on a gravitational direction.

Unless explicitly described to the contrary, the word “comprise” and variations such as “comprises” or “comprising” will be understood to imply the inclusion of stated elements but not the exclusion of any other elements.

Throughout the specification, a plane view represents a view for observing a side that is parallel to two directions (e.g., a first direction (DR1) and a second direction (DR2)) crossing each other, and a cross-sectional view represents a view for observing a side that is cut in a direction (e.g., a third direction (DR3)) that is perpendicular to a side that is parallel to the first direction (DR1) and the second direction (DR2).

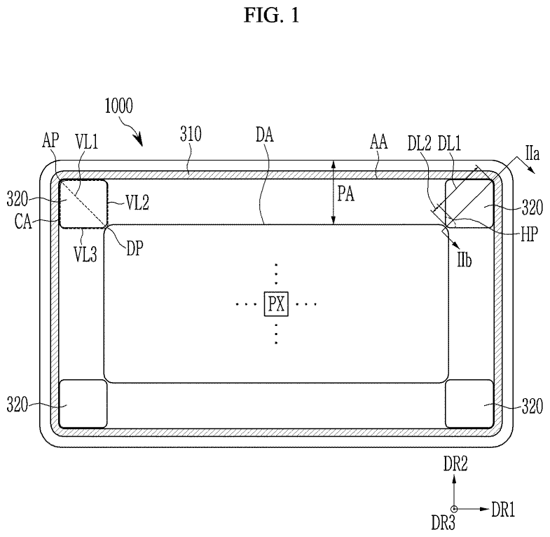

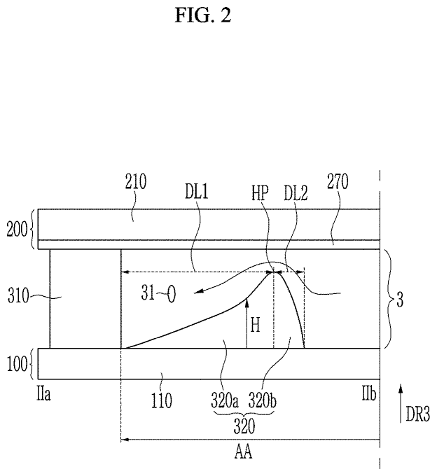

A liquid crystal display according to an exemplary embodiment of the present inventive concept will now be described with reference to FIG. 1 and FIG. 2.

FIG. 1 shows a top plan view of a liquid crystal display according to an exemplary embodiment of the present inventive concept, and FIG. 2 shows a cross-sectional view of a liquid crystal display shown in FIG. 1 with respect to a line IIa-IIb.

Referring to FIG. 1, the liquid crystal display 1000 includes a display area (DA) that is a region for displaying an image in a plan view and a peripheral area (PA) disposed around the display area (DA). The display area (DA) includes a plurality of pixels PX for displaying images. The pixel PX is the smallest discrete component of an image in the liquid crystal display 1000, and it may display one of primary colors including red, green, and blue according to an input image signal.

Referring to FIG. 2, the liquid crystal display 1000 includes a first display panel 100, a second display panel 200, a liquid crystal layer 3 disposed between the first display panel 100 and the second display panel 200, and a sealant 310.

The first display panel 100 may include a first substrate 110 that is an insulation substrate, and the second display panel 200 may include a second substrate 210 that is an insulation substrate. The first display panel 100 may include a plurality of thin film transistors and a plurality of pixel electrodes, and the second display panel 200 may include a common electrode 270 disposed between the second substrate 210 and the liquid crystal layer 3. The common electrode 270 may transmit a common voltage. The common electrode 270 may be disposed on the first display panel 100.

The sealant 310 is disposed in the peripheral area (PA), and has a shape of a closed loop surrounding the display area (DA). In a plan view, an internal region surrounded by the sealant 310 will be referred to as an active area (AA). The active area (AA) includes the display area (DA).

The active area (AA) may have various shapes such as a rectangle or a rectangle with round corners in a plan view. In the present exemplary embodiment, the active area (AA) will have a polygonal shape in a plan view. In this case, the active area (AA) may include two sides neighboring each other and extending in different directions, and a corner disposed between the two sides. The corner may be a sharp corner or a rounded corner.

The display area (DA) may have a corner (DP) and the active area (AA) may have a corner (AP). A line connecting the corner (DP) of the display area (DA) and the corner (AP) of the active area (AA) is a first line VL1. The corner area (CA) is disposed between the corner (DP) of the display area (DA) and the corner (AP) of the active area (AA). The corner area (CA) may have substantially a rectangular shape surrounded by a second line VL2, a line opposing the second line VL2, a third line VL3, and a line opposing the third line VL3. The angle formed by the second line VL2 and the third line VL3 with respect to the first line VL1 may be about 45 degrees, and it may be less than or greater than 45 degrees.

The liquid crystal layer 3 includes a plurality of liquid crystal molecules 31 with dielectric anisotropy. The liquid crystal layer 3 is disposed in a region surrounded by the sealant 310, that is, the active area (AA).

The first display panel 100 may include a protrusion 320 disposed between the first substrate 110 and the second substrate 200, and protruding toward the second substrate 200 in a cross-sectional view. The protrusion 320 may be disposed in the corner area (CA) of the active area (AA) which is disposed between the sealant 310 and the display area (DA). FIG. 1 shows an example that the protrusions 320 are mainly disposed in the corner areas (CA) of the active area (AA), and the protrusion 320 has a similar planar shape to the planar shape of the corner area (CA) of the active area (AA).

In a plan view, the corner of the protrusion 320 may be rectangular or round.

Referring to FIG. 1 and FIG. 2, in the cross-sectional view of a liquid crystal display shown in FIG. 1 with respect to a line IIa-IIb, a portion of the protrusion 320 having a highest height (H) (which will also be referred to as a height of the protrusion 320) with respect to an upper surface of the first substrate 110 will be referred to as a peak (HP) of the protrusion 320. Here, the upper surface of the protrusion 320 is a surface that faces the liquid crystal layer 3.

The protrusion 320 may include a first portion 320a disposed between the peak (HP) and the sealant 310 and a second portion 320b disposed between the peak (HP) and the display area (DA).

In the cross-section with respect to a line IIa-IIb, a distance DL1 to the peak (HP) from an edge which is adjacent to the sealant 310 is longer than a distance DL2 to the peak (HP) from an edge which is away from the sealant 310. Here, the distances DL1 and DL2 may be distances measured in a direction parallel to the upper surface of the first substrate 110. Particularly, the peak (HP) may be close to or coincide with the edge of the protrusion 320 which is away from the sealant 310 among the edges of the protrusion 320. That is, the distance DL2 may be close to 0 or may be substantially 0.

The height (H) of the first portion 320a may increase gradually as the distance from the sealant 310 increases. An inclination angle of the first portion 320a of the protrusion 320 may be constant, increase, or decrease as the distance from the sealant 310 increases. FIG. 2 illustrates an example in which the inclination angle increases as the distance from the sealant 310 increase. In this case, the upper surface of the first portion 320a of the protrusion 320 may have a concave portion and the present exemplary embodiment is not limited thereto.

With reference to the cross-sectional configuration shown in FIG. 2, the inclination angle of the upper surface of the first portion 320a is less than the inclination angle of the upper surface of the second portion 320b. Further, as described above, in a plan view, the length of the first portion 320a of the protrusion 320, that is, the distance DL1 to the peak (HP) from the edge of the protrusion 320 adjacent to the sealant 310, is greater than the length of the second portion 320b of the protrusion 320, that is, the distance DL2 to the peak (HP) from the edge of the protrusion 320 away from the sealant 310. The distance DL1 from the edge of the protrusion 320 adjacent to the sealant 310 to the top of the protrusion 320 is smaller than the distance DL2 between the protrusion 320 and the protrusion 320. Therefore, the angle formed by the upper surface of the first portion 320a of the protrusion 320 and the lower surface of the second display panel 200 is less than the angle formed by the upper surface of the second portion 320b of the protrusion 320 and the lower surface of the second display panel 200. A gap between the upper surface of the first portion 320a of the protrusion 320 and the lower surface of the second display panel 200 may gradually increase as it approaches the sealant 310.

The highest peak (HP) of the protrusion 320 may be separated from the lower surface of the second display panel 200 by a predetermined distance. Accordingly, when the liquid crystal display 1000 is pressed by an external pressure, the protrusion 320 may function as an auxiliary spacer to support maintaining of the gap between the first display panel 100 and the second display panel 200.

A method for manufacturing a liquid crystal display according to an exemplary embodiment of the present inventive concept includes a process for respectively forming a first display panel 100 and a second display panel 200, forming a liquid crystal layer 3, and bonding the first display panel 100 and the second display panel 200 with each other. In detail, the active area (AA) is defined by forming a sealant 310 on one of the first display panel 100 and the second display panel 200. A liquid crystal material including liquid crystal molecules 31 is dispensed on one of the first display panel 100 and the second display panel 200 on which the sealant 310 is formed. The liquid crystal dispensing process may use a one drop filling scheme for dispensing a liquid crystal material at regular intervals. The first display panel 100 and the second display panel 200 are arranged and bonded with each other under vacuum, and the sealant 310 is hardened or cured to thereby manufacture the above-described liquid crystal display 1000.

In this process, during a process for bonding the first display panel 100 and the second display panel 200, the liquid crystal material may be spread toward the edge of the active area (AA), so the entire active area (AA) may be filled with the liquid crystal material including liquid crystal molecules 31. However, as shown in FIG. 1, when the active area (AA) has a corner, a region disposed near the corner, that is, the corner area (CA), may be filled with a lesser amount of the liquid crystal material than the region disposed inside the active area (AA). As described, when the region is filled with a lesser amount of the liquid crystal material, it may be seen as stains from the outside.

According to an exemplary embodiment of the present inventive concept, the angle formed by the upper surface of the first portion 320a of the protrusion 320 and the lower surface of the second display panel 200 is less than the angle formed by the upper surface of the second portion 320b of the protrusion 320 and the lower surface of the second display panel 200, the gap between the upper surface of the first portion 320a of the protrusion 320 and the lower surface of the second display panel 200 is less than the gap between the upper surface of the second portion 320b of the protrusion 320 and the lower surface of the second display panel 200, and it gradually increases as it approaches the sealant 310, so when the liquid crystal material which is dispensed on the first display panel 100 or the second display panel 200 spreads toward the outside from the inside of the active area (AA) through a gap between the peak (HP) and the bottom of the second display panel 200 or the top of the first display panel 100, greater surface tension and capillary pressure may be applied to the liquid crystal molecules 31.

Accordingly, the liquid crystal material including liquid crystal molecules 31 may be further well spread toward the outside in the corner area (CA) of the active area (AA), so the liquid crystal molecules 31 may be fully filled up to the edge of the active area (AA) in the corner area (CA).

According to another exemplary embodiment, the protrusion 320 may be disposed on the second display panel 200. In this case, the protrusion 320 may protrude toward the first display panel 100. In an exemplary embodiment, the upper surface of the above-described protrusion 320 is changed to the lower surface of the protrusion 320, and the lower surface of the second display panel 200 is changed to the upper surface of the first display panel 100, so the same characteristics and effect as those that are previously described may be identically applicable.

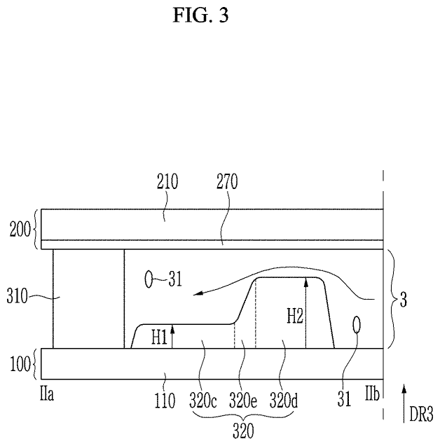

A liquid crystal display according to an exemplary embodiment of the present inventive concept will now be described with reference to FIG. 3.

FIG. 3 shows another exemplary cross-sectional view of a liquid crystal display shown in FIG. 1 with respect to a line IIa-IIb.

Referring to FIG. 3, the liquid crystal display according to the present exemplary embodiment is mostly equivalent to the above-described exemplary embodiment of FIG. 2, but the shape of the protrusion 320 may be different in a cross-sectional view. In detail, the protrusion 320 may include a third portion 320c and a fourth portion 320d of which heights of the upper surface of the protrusion 320 from the upper surface of the first substrate 110 are different from each other, and a fifth portion 320e disposed between the third portion 320c and the fourth portion 320c. The third portion 320c, the fourth portion 320d, and the fifth portion 320e are connected to each other and disposed between the first portion and the second portion. The third portion 320c of the protrusion 320 is disposed closer to the sealant 310 than the fourth portion 320d.

The height H1 of the upper surface of the third portion 320c is less than the height H2 of the upper surface of the fourth portion 320d, and the height of the upper surface of the fifth portion 320e may gradually vary between the heights H1 and H2.

The fifth portion 320e may be omitted.

In the present exemplary embodiment, the fourth portion 320d of the protrusion 320 may be separated from the lower surface of the second display panel 200. When the liquid crystal display 1000 is pressed by an external pressure, the protrusion 320 may function as an auxiliary spacer to support maintaining of the gap between the first display panel 100 and the second display panel 200.

The protrusion 320 according to the present exemplary embodiment may be formed by using a photolithography process using a halftone mask or a slit mask in the manufacturing process.

According to the present exemplary embodiment, the upper surfaces of the protrusion 320 have a stepped curve shape and the upper surface of the tallest protrusion form a relatively small gap with the lower surface of the second display panel 200, so the liquid crystal material passing through the gap formed between the tallest upper surface of the protrusion 320 and the lower surface of the second display panel 200 may receive great surface tension and capillary pressure in the process for forming a liquid crystal layer 3 of the liquid crystal display. Therefore, the liquid crystal material including liquid crystal molecules 31 may be easily spread toward the outside in the corner area (CA) of the active area (AA), so the liquid crystal molecules 31 may be sufficiently filled up to the edge of the active area (AA) in the corner area (CA).

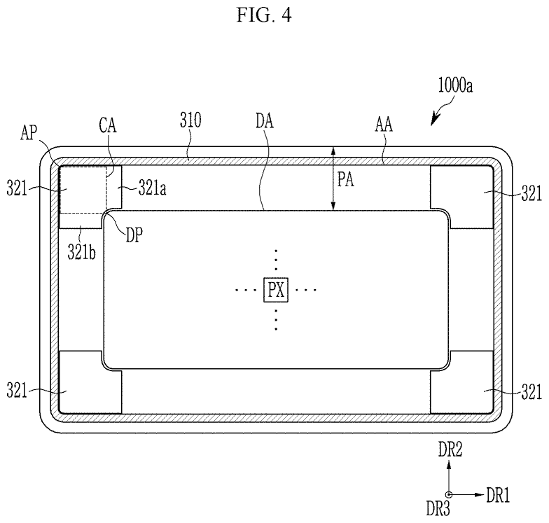

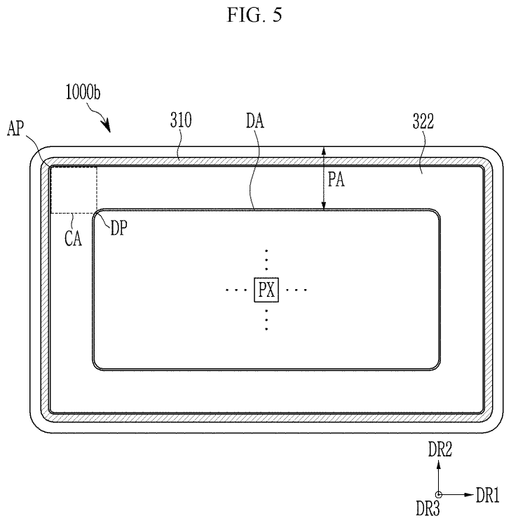

A liquid crystal display according to exemplary embodiments of the present inventive concept will now be described with reference to FIG. 4 and FIG. 5 together with the above-described drawings.

FIG. 4 and FIG. 5 show top plan views of a liquid crystal display according to an exemplary embodiment of the present inventive concept.

Referring to FIG. 4, the liquid crystal display 1000a according to the present exemplary embodiment is mostly equivalent to the above-described exemplary embodiments, and it may include a protrusion 321 having a different planar shape.

The protrusion 321 may extend further toward a lateral direction and a vertical direction than the protrusion 320 as disclosed in FIG. 1 and may have a portion extending from the corner area (CA) along the lateral direction and the vertical direction not to overlap the display area (DA). In detail, as shown in FIG. 4, the protrusion 321 may include a portion disposed in the corner area (CA) and portions 321a and 321b connected thereto and extend along the lateral direction and the vertical direction, respectively. The portions 321a and 321b of the protrusion 321 not disposed in the corner area (CA) may be disposed in a region between the display area (DA) and the sealant 310, and may respectively extend in a first direction DR1 (the lateral direction) or a second direction DR2 (the vertical direction). In this instance, the edge of the sealant 310 and the edge of the display area (DA) facing each other may extend in parallel to each other in the first direction DR1 or the second direction DR2.

The cross-sectional configuration of the portions 321a and 321b of the protrusion 321 may correspond to those described with reference to FIG. 2 or FIG. 3. The liquid crystal material spreading from the inside of the active area (AA) with reference to the protrusion 321 may receive a capillary pressure when spreading toward the sealant 310 along the upper surface of the protrusion 321, it may be easily spread, and it may fill up to the edge of the active area (AA) completely.

Referring to FIG. 5, the liquid crystal display 1000b according to the present exemplary embodiment mostly corresponds to the exemplary embodiment described with reference to FIG. 4, and it may a protrusion 322 which surround the display area (DA) completely. The protrusion 322 mostly corresponds to the protrusion 321 according to an exemplary embodiment described with reference to FIG. 4, and the protrusion 322 may be form in one piece. The protrusion 322 may have a shape of a closed loop completely surrounding the display area (DA) in the region between the display area (DA) and the sealant 310.

In the present exemplary embodiment, the cross-sectional configuration of the protrusion 322 may corresponds to that described with reference to FIG. 2 or FIG. 3, and hence, the liquid crystal material spreading from the inside of the active area (AA) with reference to the protrusion 322 may receive a capillary pressure when spreading toward the sealant 310 along the upper surface of the protrusion 322, it may be easily spread and it may fill up to the edge of the active area (AA) completely.

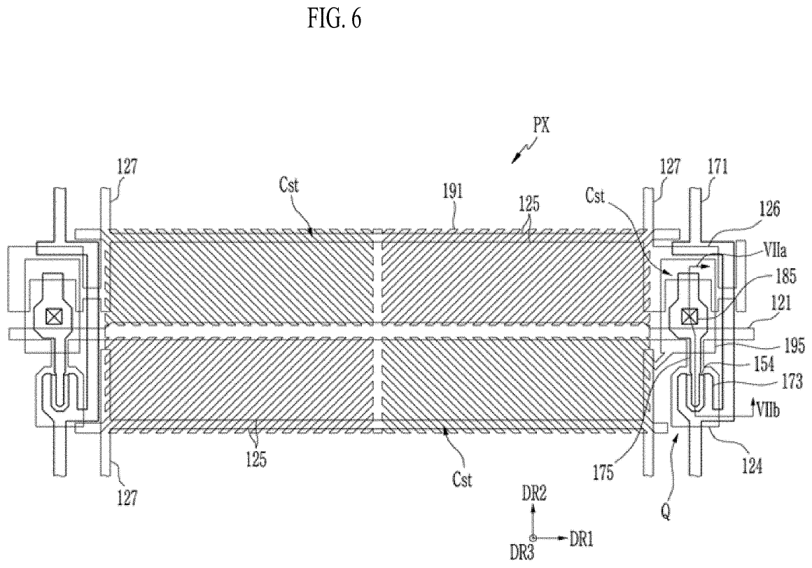

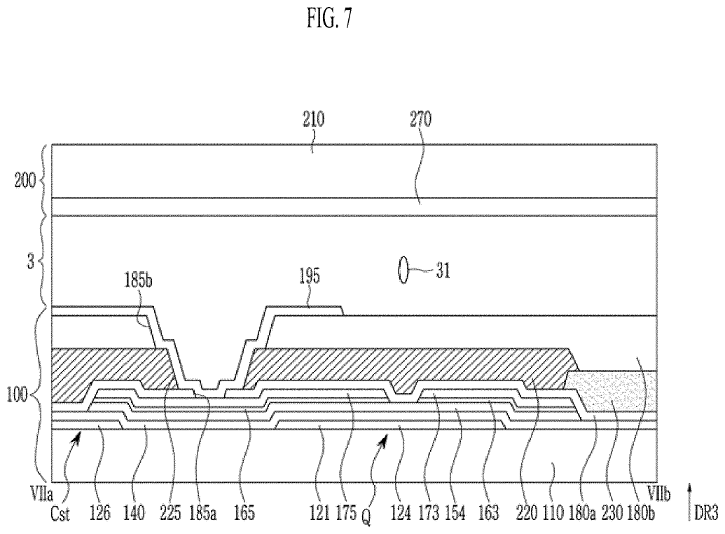

A detailed configuration of a liquid crystal display according to an exemplary embodiment of the present inventive concept will now be described with reference to FIG. 6 and FIG. 7, and based upon this, a detailed configuration of protrusions 320, 321, and 322 according to an exemplary embodiment of the present inventive concept will now be described.

FIG. 6 shows a top plan view of one pixel of a liquid crystal display according to an exemplary embodiment of the present inventive concept, and FIG. 7 shows a cross-sectional view of a liquid crystal display shown in FIG. 6 with respect to a line VIIa-VIIb.

Referring to FIG. 6 and FIG. 7, the liquid crystal display according to an exemplary embodiment of the present inventive concept includes a first display panel 100 and a second display panel 200 facing each other, and a liquid crystal layer 3 disposed between the first display panel 100 and the second display panel 200.

A gate line 121 including a gate electrode 124, and a storage electrode line 125 are disposed on the first substrate 110 in the first display panel 100.

The gate line 121 may transmit a gate signal and mainly extends in the first direction DR1.

The storage electrode line 125 may transmit a constant voltage. The storage electrode line 125 may include a pair of main lines (indicated by a reference numeral of 125) disposed in one pixel PX and extending in the first direction DR1, branches 127 connected to the main lines and extending in the second direction DR2, and a storage electrode 126.

The gate line 121 and the storage electrode line 125 may include at least one of copper (Cu), aluminum (Al), magnesium (Mg), silver (Ag), gold (Au), platinum (Pt), palladium (Pd), nickel (Ni), neodymium (Nd), iridium (Ir), molybdenum (Mo), tungsten (W), titanium (Ti), chromium (Cr), tantalum (Ta), or an alloy thereof.

A gate insulating layer 140 may be disposed on the gate line 121 and the storage electrode line 125. A semiconductor 154 including amorphous silicon, polysilicon, or an oxide semiconductor material may be disposed on the gate insulating layer 140.

Ohmic contact layers 163 and 165 may be disposed on the semiconductor 154. The ohmic contact layers 163 and 165 may be made of a material such as an n+ hydrogenated amorphous silicon to which an n-type impurity is highly doped, or it may include a silicide. The ohmic contacts 163 and 165 may be omitted.

A data line 171 and a drain electrode 175 may be disposed on the ohmic contacts 163 and 165.

The data line 171 may transmit a data voltage, and it mainly extends in the second direction DR2 and may cross the gate line 121. The data line 171 may include a source electrode 173 protruding toward the gate electrode 124.

The drain electrode 175 includes a portion separated from the data line 171 and facing the source electrode 173.

The data line 171 and the drain electrode 175 may include at least one of copper (Cu), aluminum (Al), magnesium (Mg), silver (Ag), gold (Au), platinum (Pt), palladium (Pd), nickel (Ni), neodymium (Nd), iridium (Jr), molybdenum (Mo), tungsten (W), titanium (Ti), chromium (Cr), tantalum (Ta), or an alloy thereof.

The gate electrode 124, the source electrode 173, and the drain electrode 175 form a thin film transistor (TFT) Q together with the semiconductor 154.

A first passivation layer 180a including an organic or inorganic insulating material may be disposed on the thin film transistor Q. The first passivation layer 180a may include an opening 185a disposed on the drain electrode 175.

A color filter 230 and a light blocking member 220 may be disposed on the first passivation layer 180a.

The color filter 230 may display one of three primary colors such as red, green, and blue.

The light blocking layer 220 may block a leakage of light among neighboring pixels PX. The light blocking layer 220 may include a light blocking material such as carbon black. The light blocking layer 220 may overlap most of the data line 171 and the thin film transistor Q, and may include a portion extending in the second direction DR2.

In the FIG. 7, the light blocking layer 220 is disposed over the color filter 230, however, the light blocking layer 220 may be disposed below the color filter 230.

According to another exemplary embodiment of the present inventive concept, at least one of the light blocking layer 220 or the color filter 230 may be disposed on the second display panel 200.

The light blocking layer 220 may include an opening 225 overlapping an opening 185a of the first passivation layer 180a. The opening 185a may be disposed in the opening 225.

A second passivation layer 180b may be disposed on the light blocking layer 220 and the color filter 230. The second passivation layer 180b may include an organic insulating material and may substantially include a flat upper surface. The second passivation layer 180b may include an opening 185b of the second passivation layer 180b. The opening 185b overlaps the opening 225 of the light blocking member 220.

A pixel electrode 191 may be disposed on the second passivation layer 180b. The pixel electrode 191 may include a transparent conductive material such as an ITO or an IZO, or a reflective metal such as aluminum, silver, chromium, or an alloy thereof.

A total shape of the pixel electrode 191 may be a quadrangle. FIG. 6 exemplifies a pixel electrode 191 that is longer in the first direction DR1 than in the second direction DR2.

The pixel electrode 191 may include a cross-shaped stem portion including a horizontal stem portion extending in the first direction DR1 and a vertical stem portion extending in the second direction DR2, a plurality of branch portions extending to an outside from the cross-shaped stem portion, and a contact portion 195.

The horizontal stem portion of the pixel electrode 191 may be arranged to overlap the gate line 121.

The contact portion 195 of the pixel electrode 191 may contact the drain electrode 175 through an opening 185a of the first passivation layer 180a, an opening 225 of the light blocking member 220, and an opening 185b of the second passivation layer 180b, and may be electrically connected thereto. The pixel electrode 191 may receive a data voltage from the drain electrode 175.

A common electrode 270 may be disposed below the second substrate 210 of the second display panel 200. The common electrode 270 may include a transparent conductor such as an ITO or IZO, or a metal. The common electrode 270 may receive a common voltage.

The common electrode 270 may be formed on an entire lower surface of the second substrate 210, and common electrodes 270 disposed on a plurality of pixels PX may be connected to each other to form a single piece. The common electrode 270 may include cutout portions from which a part of the common electrode 270 is removed. The liquid crystal layer 3 corresponds to the above-described liquid crystal layer 3, and no identical descriptions will be disposed.

The pixel electrode 191 and the common electrode 270 form a liquid crystal capacitor together with the liquid crystal layer 3 disposed therebetween as an insulating layer forming the capacitor, and the liquid crystal capacitor maintains the applied voltage even after the thin film transistor Q is turned off. The pixel electrode 191 or the drain electrode 175 overlaps the storage electrode line 125 that includes a storage electrode 126 with the gate insulating layer 140 or the passivation layers 180a and 180b disposed therebetween, and forms the storage capacitor Cst. To acquire enough capacitance of the storage capacitor Cst, part of the light blocking member 220 or the color filter 230 may be removed from the portion forming the storage capacitor Cst.

The liquid crystal display according to the present exemplary embodiment may be curved or capable of curving in the first direction DR1.

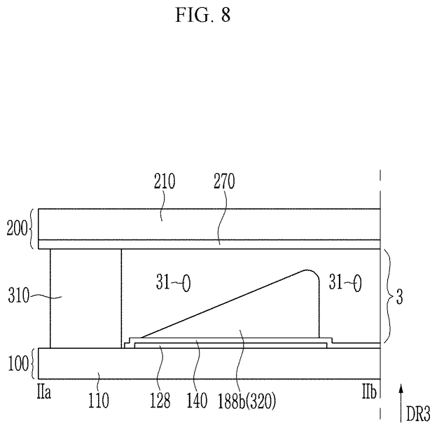

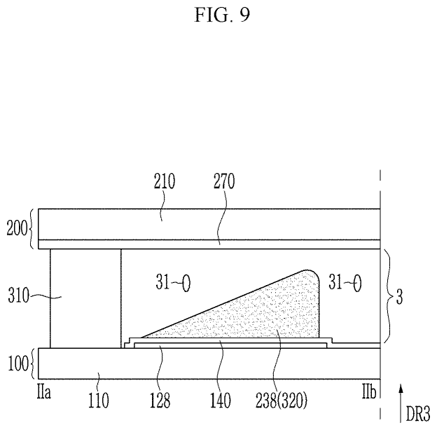

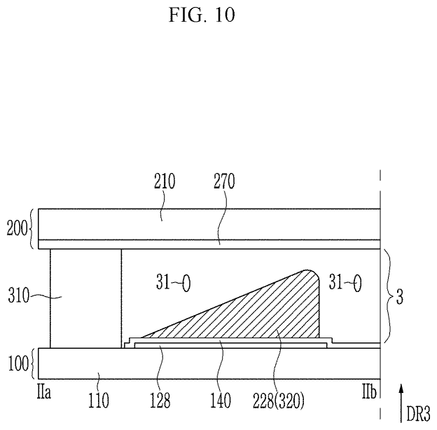

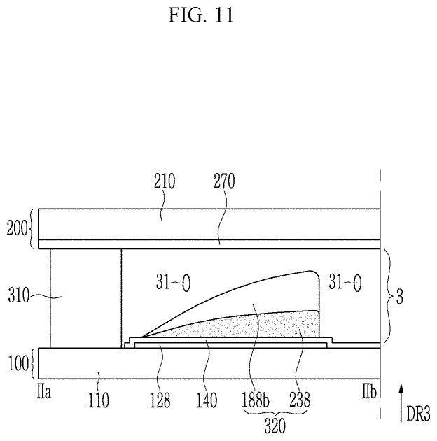

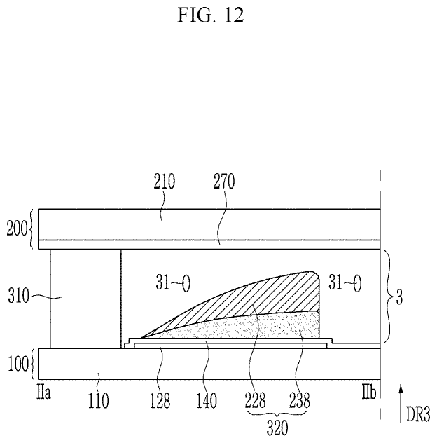

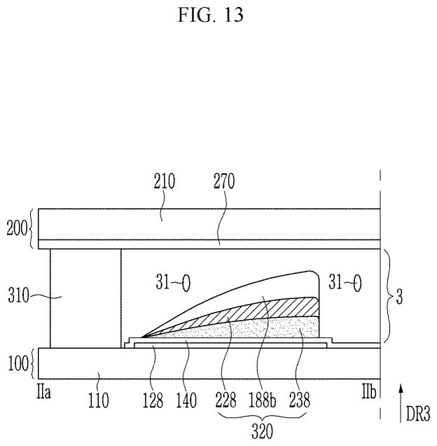

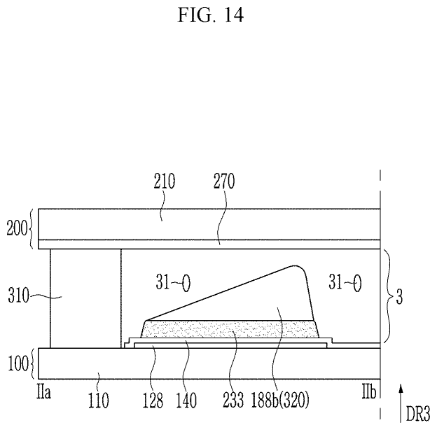

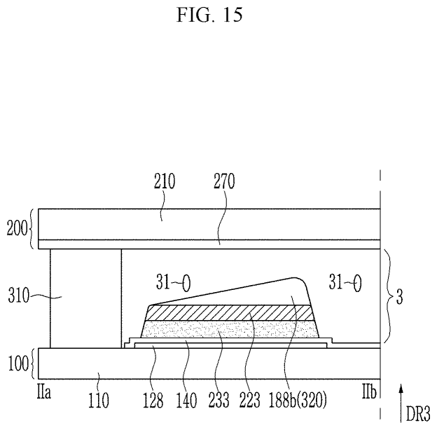

A liquid crystal display according to an exemplary embodiment of the present inventive concept will now be described with reference to FIG. 8, FIG. 9, FIG. 10, FIG. 11, FIG. 12, FIG. 13, FIG. 14, and FIG. 15 together with the above-shown drawings.

FIG. 8, FIG. 9, FIG. 10, FIG. 11, FIG. 12, FIG. 13, FIG. 14, and FIG. 15 show other examples of the cross-sectional diagram of the liquid crystal display shown in FIG. 1 with respect to a line IIa-IIb.

The liquid crystal display according to the present exemplary embodiments mostly corresponds to the above-described exemplary embodiments, protrusion 320, 321, and 322. The reference numeral 320 shown in FIG. 8, FIG. 9, FIG. 10, FIG. 11, FIG. 12, FIG. 13, FIG. 14, and FIG. 15 may also be 321 or 322. Descriptions on the equivalent constituent elements will be omitted.

According to the present exemplary embodiments, the above-described protrusions 320, 321, and 322 may include at least one layer including an organic material and a material with photosensitivity. For example, the protrusions 320, 321, and 322 may be disposed in the same layer and include a same material as the at least one of the color filters 230, the light blocking member 220, or the second passivation layer 180b, and may include at least one layer that may be simultaneously formed in the same manufacturing process as the at least one of the color filters 230, the light blocking member 220, or the second passivation layer 180b. These various examples will now be described with reference to respective drawings.

Referring to FIG. 8, a conductor 128 may be disposed on the first substrate 110 of the first display panel 100. The conductor 128 may be disposed on the same layer, include a same material and be simultaneously formed in the same manufacturing process as the above-described gate line 121.

Differing from the present exemplary embodiment, the conductor 128 may be disposed on the same layer, include the same material and be simultaneously formed in the same manufacturing process as the data line 171. In this case, the conductor 128 may be disposed on the gate insulating layer 140.

A protrusion 188b may be disposed on the gate insulating layer 140. The protrusion 188b may be disposed on the same layer, include the same material and be simultaneously formed in the same manufacturing process as the above-described second passivation layer 180b. The protrusion 188b may have the same characteristics as the protrusions 320, 321, and 322 as detailed examples of the protrusions 320, 321, and 322 according to the above-described various exemplary embodiments.

Referring to FIG. 9, the display device according to the present exemplary embodiment mostly corresponds to the exemplary embodiment described with reference to FIG. 8 except a protrusion 238. The protrusion 238 may be disposed on the same layer, include the same material and be simultaneously formed in the same manufacturing process as the above-described color filter 230. The protrusion 238 may have the same characteristics as the protrusions 320, 321, and 322 as detailed examples of the protrusions 320, 321, and 322 according to the above-described various exemplary embodiments.

Referring to FIG. 10, the display device according to the present exemplary embodiment mostly corresponds to the exemplary embodiment described with reference to FIG. 8 except a protrusion 228. The protrusion 228 may be disposed in the same layer, include the same material and be simultaneously formed in the same manufacturing process as the above-described light blocking member 220. The protrusion 228 may have the same characteristics as the protrusions 320, 321, and 322 as detailed examples of the protrusions 320, 321, and 322 according to the above-described various exemplary embodiments.

Referring to FIG. 11, the display device according to the present exemplary embodiment mostly corresponds to the exemplary embodiment described with reference to FIG. 9, and the protrusion 188b may be disposed to overlap the protrusion 238 in the third direction DR3. The protrusion 188b may have the same or similar characteristics as/to the protrusion 188b described with reference to FIG. 8. The thickness of the protrusion 238 and the protrusion 188b may gradually decrease as a distance to the sealant 310 decrease.

A combined structure of protrusions 238 and 188b may have the same characteristics as the protrusions 320, 321, and 322 as detailed examples of the protrusions 320, 321, and 322 according to the above-described various exemplary embodiments.

Referring to FIG. 12, the display device according to the present exemplary embodiment mostly corresponds to the exemplary embodiment described with reference to FIG. 11 except the protrusion 320. The protrusion 228 may be disposed on the protrusion 238, and may be disposed to overlap the protrusion 238 in the third direction DR3. The protrusion 228 may have the same or similar characteristics as/to the protrusion 228 described with reference to FIG. 10. A plurality of stacked protrusions 238 and 228 may have the same characteristics as the protrusions 320, 321, and 322 as detailed examples of the protrusions 320, 321, and 322 according to the above-described various exemplary embodiments.

Referring to FIG. 13, the display device according to the present exemplary embodiment mostly corresponds to the exemplary embodiment described with reference to FIG. 12 except the protrusion 320. The protrusion 188b may overlap the protrusion 228 which overlaps the protrusion 238 in the third direction DR3. The protrusion 188b may have the same or similar characteristics as/to the protrusion 188b described with reference to FIG. 8. A plurality of stacked protrusions 238, 228, and 188b may have the same characteristics as the protrusions 320, 321, and 322 as detailed examples of the protrusions 320, 321, and 322 according to the above-described various exemplary embodiments.

Referring to FIG. 14, the display device according to the present exemplary embodiment mostly corresponds to the exemplary embodiment described with reference to FIG. 8, and it may further include a color filter 233 overlapping the protrusion 188b in the third direction DR3. The color filter 233 may be disposed in the same layer, include the same material and be simultaneously formed in the same manufacturing process as the above-described color filter 230. An upper surface of the color filter 233 may be substantially flat.

Referring to FIG. 15, the display device according to the present exemplary embodiment mostly corresponds to the exemplary embodiment described with reference to FIG. 14, and a light blocking member 223 may be further disposed below the protrusion 188b. As shown, the light blocking member 223 may be disposed between the protrusion 188b. The color filter 233 may be disposed below the light blocking member 223. However, the color filter 233 may be disposed above the light blocking member 223.

In addition, the above-described protrusions 320, 321, and 322 may be configured with a combination of various layers.

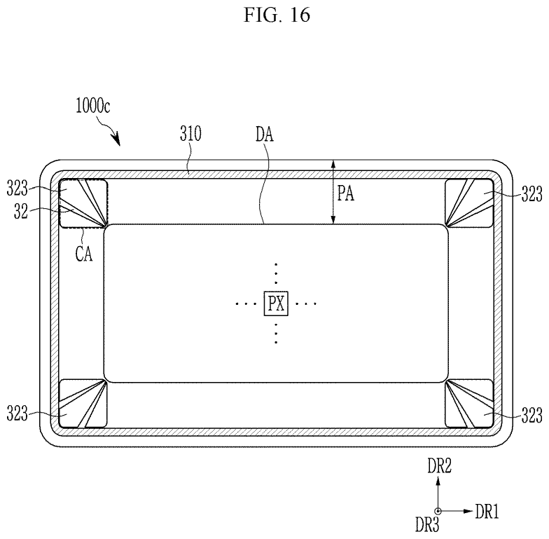

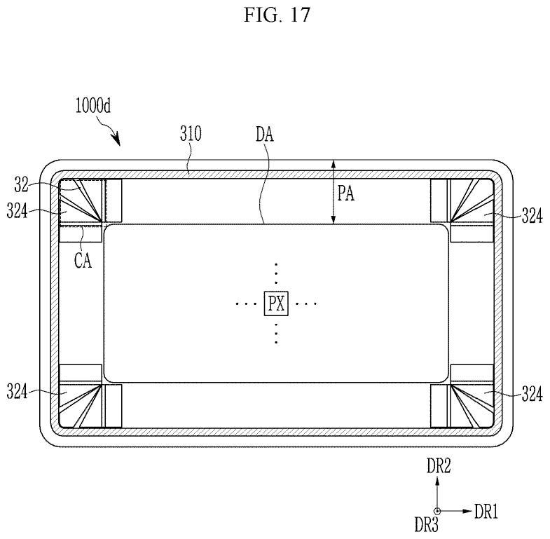

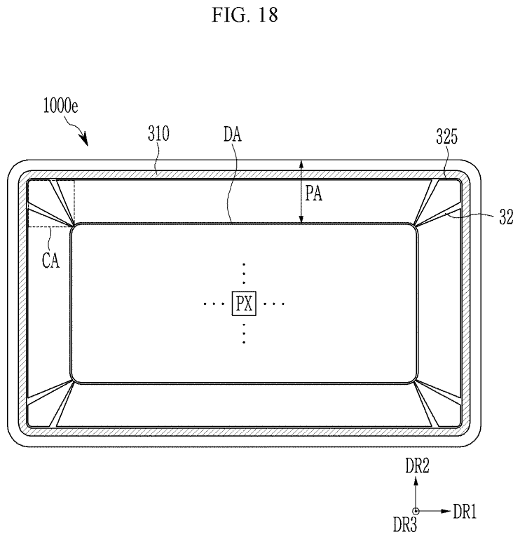

A liquid crystal display according to an exemplary embodiment of the present inventive concept will now be described with reference to FIG. 16, FIG. 17, and FIG. 18 together with the above-shown drawings.

FIG. 16, FIG. 17, and FIG. 18 show top plan views of a liquid crystal display according to an exemplary embodiment of the present inventive concept.

Referring to FIG. 16, a liquid crystal display 1000c according to the present exemplary embodiment mostly corresponds to the liquid crystal display 1000 described with reference to FIG. 1 except the protrusion 320. The protrusion 323 may include a plurality of separated portions with at least one gap 32 disposed between adjacent separated portions. The cross-sectional configuration and shape of the protrusion 323 may be similar to or the same as the cross-sectional configurations and shapes of the protrusions 320, 321, and 322 according to the above-described various exemplary embodiments. The entire planar shape of one protrusion 323 that is included in a plurality of separated portions with at least one gap 32 disposed between the adjacent separated portions may be similar to the planar shape of the above-described one protrusion 320.

In a plan view, the gap 32 may extend toward the sealant 310 from the corner of the display area (DP).

According to the present exemplary embodiment, when the liquid crystal material which is dispensed on the first display panel 100 or the second display panel 200 spreads toward the edge of the active area (AA) through a gap between the protrusion 323 and the second display panel 200 or the first display panel 100 in the process for forming a liquid crystal layer 3 of a liquid crystal display in the above-described manufacturing method, it may be efficiently spread because of the above-noted capillary pressure, and it may also be spread through the gap 32, thereby the liquid crystal layer 3 may be uniformly filled up to the external edge of the corner area (CA) of the active area (AA).

Referring to FIG. 17, a liquid crystal display 1000d according to the present exemplary embodiment mostly corresponds to the liquid crystal display 1000a described with reference to FIG. 4 except a protrusion 324. The protrusion 324 may include a portion that is divided into a plurality of separated portions with at least one gap 32 disposed between adjacent separated portions. The cross-sectional configuration and the shape of the protrusion 324 may be similar to or identical with the cross-sectional configurations and the shapes of the protrusions 320, 321, and 322 according to various exemplary embodiments. The entire planar shape of one protrusion 324 that is included in a plurality of separated portions may be similar to the planar shape of the above-described protrusion 321.

Effects caused by the configuration in which the protrusion 323 includes a gap 32 correspond to the above-described effects.

Referring to FIG. 18, the liquid crystal display 1000e according to the present exemplary embodiment mostly corresponds to the liquid crystal display 1000b described with reference to FIG. 5 except a protrusion 325 which includes a plurality of separated portions disposed with at least one gap 32 disposed between adjacent separated portions. The cross-sectional structure and the shape of the protrusion 325 may be similar to or equivalent to the cross-sectional structures and the shapes of the protrusions 320, 321, and 322 according to the above-described various exemplary embodiments. The entire planar shape of one protrusion 325 that includes a plurality of separated portions may be similar to the planar shape of the above-described one protrusion 322.

In the present exemplary embodiment, the gap 32 is disposed in the corner area (CA), however, locations of the gap 32 is not limited to this. The gap 32 may be disposed in any active area (AA) disposed between the display area (DA) and the sealant 310 in addition to the corner area (CA).

The effects caused by the structure in which the protrusion 323 includes the gap 32 correspond to the effects that are already described above.

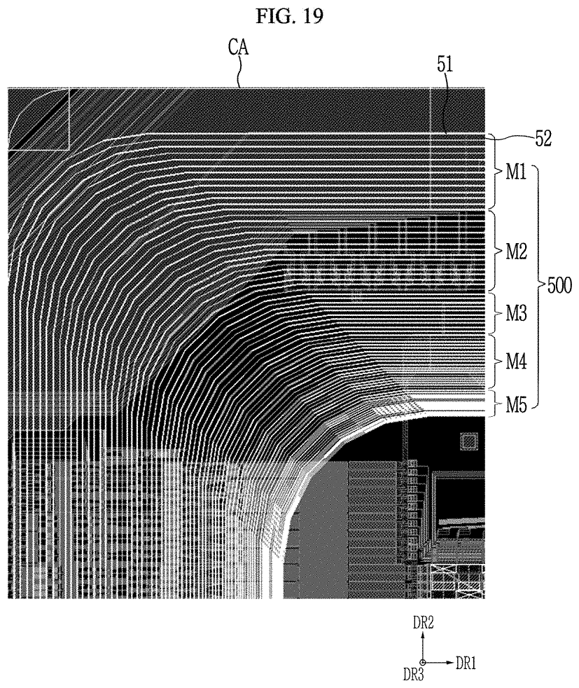

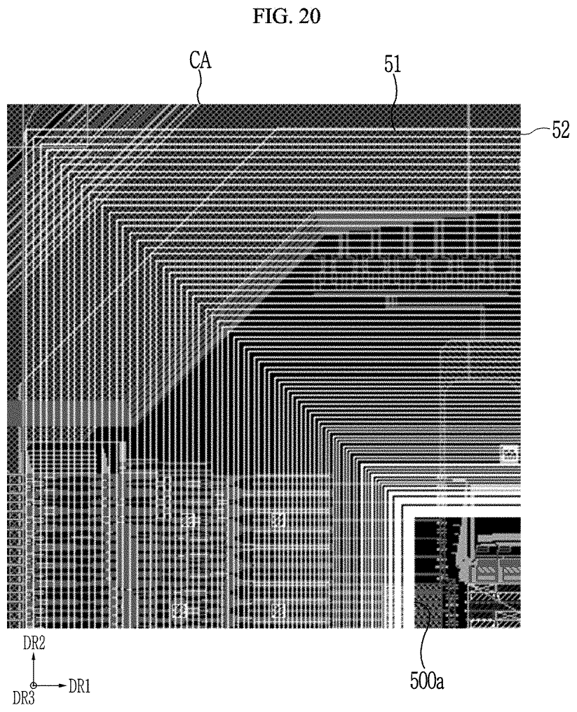

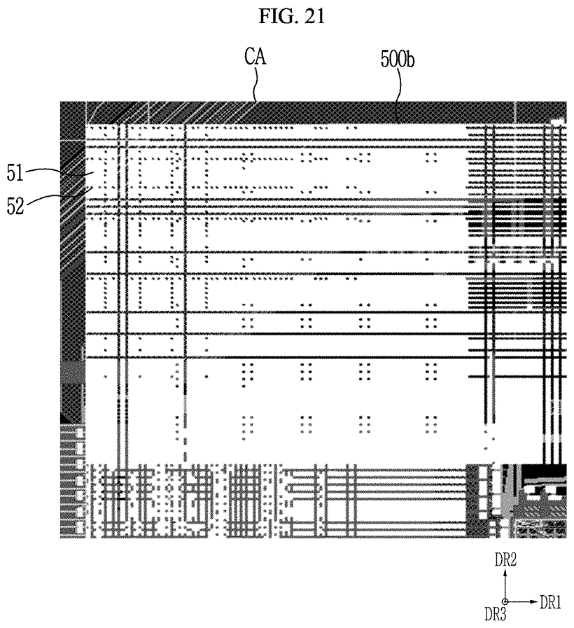

A photo-mask used in one process in a method for manufacturing a liquid crystal display according to an exemplary embodiment of the present inventive concept will now be described with reference to FIG. 19, FIG. 20, FIG. 21, and FIG. 22 together with the above-described drawings.

FIG. 19, FIG. 20, FIG. 21, and FIG. 22 show top plan views of a photo-mask used in one process in a method for manufacturing a liquid crystal display shown in FIG. 1 according to an exemplary embodiment, and in further detail, they show a part corresponding to one corner area (CA) of the active area (AA) from among photo-masks 500, 500a, 500b, and 500c used in the process for forming the protrusions 320, 321, and 322 according to the above-described various exemplary embodiments through a photolithography process. A case in which materials of the protrusions 320, 321, and 322 have positive photosensitivity will be exemplified in the present exemplary embodiment.

Referring to FIG. 19, the photo-mask 500 for forming the protrusions 320, 321, and 322 according to an exemplary embodiment of the present inventive concept may include a light blocking portion 51 for blocking light and a light transmitting portion 52 for transmitting light. The light blocking portion 51 and the light transmitting portion 52 are alternately disposed. The light transmitting portion 52 may have a slit shape, and the light blocking portion 51 may have a bar shape.

The photo-mask 500 may include a plurality of regions M1, M2, M3, M4, and M5 which have different ratios of the light transmitting portion 52. The ratio of the width of the light transmitting portion 52 to the width of the light blocking portion 51 may increase as the regions M1, M2, M3, M4 and M5 become closer to the external edge of the photo-mask 500. Suppose ratios of the width of the light transmitting portion 52 to the width of the light blocking portion 51 in the regions M1, M2, M3, M4 and M5 are R_{M1}, R_{M2}, R_{M3}, R_{M4} and R_{M5}, respectively. The ratios satisfy the relation R_{M1}>R_{M2}>R_{M3}>R_{M4}>R_{M5}.

The width of the light blocking portion 51 and the width of the light transmitting portion 52 of the photo-mask 500 may be equal to or less than a resolution of a light exposer used in the photo-process. For example, the width of the light blocking portion 51 and the width of the light transmitting portion 52 may be equal to or less than about 4 micrometers. The width of the light blocking portion 51 may be constant or variable. The width of the light transmitting portion 52 may vary according to the regions M1, M2, M3, M4, and M5.

In the respective regions M1, M2, M3, M4, and M5, the ratio of the widths of the light blocking portion 51 and the light transmitting portion 52 may be constant or variable. When the ratio of the widths of the light blocking portion 51 and the light transmitting portion 52 changes in the respective regions M1, M2, M3, M4, and M5, the ratio of the width of the light transmitting portion 52 to the width of the light blocking portion 51 may gradually increase as it becomes close to the external edge of the photo-mask 500, for example, close to the sealant 310. As a whole, the ratio of the width of the light transmitting portion 52 to the width of the light blocking portion 51 may gradually change.

Corners of the light blocking portion 51 and the light transmitting portion 52 of the photo-mask 500 on the portion corresponding to the corner area (CA) of the liquid crystal display may be round, but they are not limited thereto. The corners of the protrusions 320, 321, and 322 formed by using the photo-mask 500 according to the present exemplary embodiment may be round.

As described, when the ratio of the width of the light transmitting portion 52 to the width of the light blocking portion 51 increases step by step as it becomes close to the external edge of the photo-mask 500, transmittance of light of the photo-mask 500 gradually increases as it becomes close to the external edge of the photo-mask 500. According to the photolithography process using the photo-mask 500, the thickness of the protrusions 320, 321, and 322 gradually decrease to increase the surface tension and the capillary pressure as they become closer to the sealant 310 in the peripheral area (PA) in a like manner of an exemplary embodiment.

Referring to FIG. 20, the photo-mask 500a according to the present exemplary embodiment mostly corresponds to the above-described photo-mask 500, and the corners of the light blocking portion 51 and the light transmitting portion 52 of the photo-mask 500a in the corner area (CA) of the liquid crystal display may substantially form a right angle. The corners of the protrusions 320, 321, and 322 formed by using a photo-mask 500a according to the present exemplary embodiment may be sharper than the corners of the protrusions 320, 321, and 322 formed by using a photo-mask 500 according to an exemplary embodiment shown in FIG. 19.

Referring to FIG. 21, the photo-mask 500b according to the present exemplary embodiment mostly corresponds to the above-described photo-mask 500a, and the light transmitting portion 52 may have a dot shape and not a slit shape. In this case, while a remaining portion of the photo-mask 500b is the light blocking portion 51, a plurality of light transmitting portions 52 in a dot shape may be disposed with different densities depending on positions. According to the present exemplary embodiment, a density of the light transmitting portion 52 gradually increases as it becomes closer to the external edge of the photo-mask 500b, so the transmittance of the photo-mask 500b may gradually increase as it becomes closer to the external edge of the photo-mask 500b.

A diameter of the light transmitting portion 52 formed with dots may have a resolution that is equal to or less than the resolution of the light exposer used in the photo-process. For example, the diameter of the light transmitting portion 52 of the photo-mask 500b may be equal to or less than about 4 micrometers.

According to another exemplary embodiment, the diameter of the dot-shaped light transmitting portion 52 may be changed according to the position of the photo-mask 500b. That is, in a plan view of the photo-mask 500b, the density of the light transmitting portion 52 may vary according to the position as shown, or it may be constant, and the diameter of the light transmitting portion 52 may gradually increase as it becomes closer to the outside of the photo-mask 500b, and the transmittance of the photo-mask 500b may gradually increase as it becomes closer to the external edge of the photo-mask 500b.

Referring to FIG. 22, the photo-mask 500c according to the present exemplary embodiment, differing from the above-described photo-mask 500, may include a halftone region M6 for transmitting part of light, and a light blocking region M7 for blocking light. The halftone region M6 may be disposed outside the light blocking region M7. By using the photo-mask 500c, the above-described protrusion 320 according to an exemplary embodiment shown in FIG. 3 may be formed. A third portion 320c of the protrusion 320 may be formed on the portion corresponding to the halftone region M6 of the photo-mask 500c, and a fourth portion 320d of the protrusion 320 may be formed on the portion corresponding to the light blocking region M7.

When the materials of the protrusions 320, 321, and 322 have negative photosensitivity, the positions of the light blocking portion 51 and the light transmitting portion 52 may be exchanged in an exemplary embodiment described with reference to FIG. 19, FIG. 20, and FIG. 21, and the light blocking region M7 may be the light transmitting region for transmitting light and the light transmitting region M6 may be the light blocking region for blocking light in an exemplary embodiment described with reference to FIG. 22.

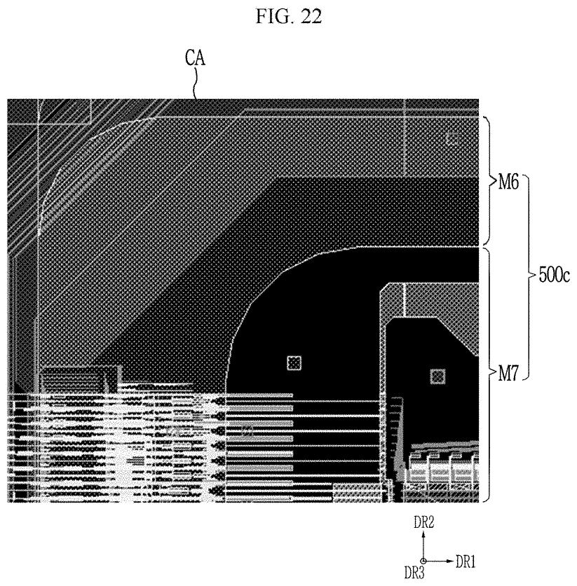

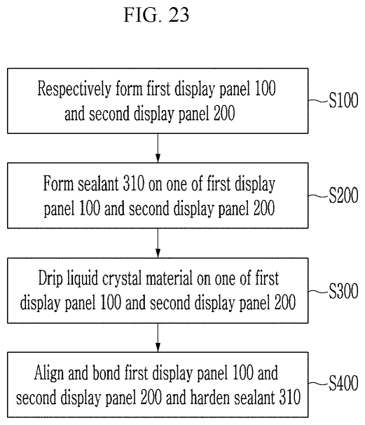

Lastly, a method for manufacturing a liquid crystal display according to an exemplary embodiment of the present inventive concept will now be described with reference to FIG. 23 together with the above-described drawings.

FIG. 23 shows a flowchart of a predetermined process in a method for manufacturing a liquid crystal display according to an exemplary embodiment of the present inventive concept.

A first display panel 100 and a second display panel 200 are formed (S100). Here, the protrusions 320, 321, and 322 according to the above-described various exemplary embodiments may be formed in the stage for forming a first display panel 100, and this process may include a photolithography process using photo-masks 500, 500a, 500b, and 500c according to the above-described various exemplary embodiments.

An active area (AA) is defined by forming a sealant 310 on one of the first display panel 100 and the second display panel 200 (S200).

A liquid crystal material including liquid crystal molecules 31 is dispensed to one of the first display panel 100 and the second display panel 200 (S300).

The first display panel 100 and the second display panel 200 are arranged and bonded to each other under vacuum and the sealant 310 is hardened (S400), thereby manufacturing the liquid crystal display according to the above-described various exemplary embodiments.

While this inventive concept has been described in connection with what is presently considered to be practical exemplary embodiments, it is to be understood that the inventive concept is not limited to the disclosed embodiments. On the contrary, it is intended to cover various modifications and equivalent arrangements included within the spirit and scope of the appended claims.

What is claimed is:

1. A liquid crystal display comprising:
a first display panel and a second display panel including a display area for displaying an image and a peripheral area surrounding the display area in a plan view;
a sealant disposed between the first display panel and the second display panel and having a shape of a closed loop surrounding the display area in the plan view;
a liquid crystal layer disposed between the first display panel and the second display panel and including liquid crystal molecules; and
a protrusion disposed on the first display panel, disposed between the display area and the sealant in the plan view, and protruding toward the second display panel,
wherein the first display panel includes a first substrate, and
the protrusion includes:
a peak where the protrusion has a highest height with respect to an upper surface of the first substrate,
a first portion disposed between the peak and the sealant, and
a second portion disposed between the peak and the display area, and
wherein an inclination angle of an upper surface of the first portion is less than an inclination angle of an upper surface of the second portion in a cross-sectional view.

2. The liquid crystal display of claim 1, wherein
a distance to the peak from an edge of the protrusion which is disposed adjacent to the sealant is longer than a distance to the peak from an edge of the protrusion which is disposed away from the sealant.

3. The liquid crystal display of claim 2, wherein
an active area is defined as an area surrounded by the sealant in the plan view,
the active area includes a corner area disposed between a corner of the active area and a corner of the display area facing each other, and
the protrusion includes a portion disposed in the corner area.

4. The liquid crystal display of claim 3, wherein
the display area includes a first corner adjacent to the corner area and two edges of the display area meet at the first corner, and
the protrusion further includes a portion disposed between one of the two edges of the display area and the sealant.

5. The liquid crystal display of claim 3, wherein
the protrusion has a shape of a closed loop disposed between an edge of the display area and the sealant.

6. The liquid crystal display of claim 1, further comprising
at least one of a light blocking layer, a color filter or a passivation layer disposed in the display area,
wherein the passivation layer includes an organic insulating material, and
the protrusion is disposed on a same layer and includes a same material as at least one of the light blocking layer, the color filter, or the passivation layer.

7. The liquid crystal display of claim 6, wherein
the protrusion includes a first protrusion and a second protrusion,
the first protrusion overlaps the second protrusion in a vertical direction to an upper surface of the first substrate, and
a thickness of the first protrusion and a thickness of the second protrusion gradually decrease as a distance from the sealant decreases.

8. The liquid crystal display of claim 1, wherein
the protrusion is divided into a plurality of separated portions with at least one gap disposed between adjacent separated portions in the plan view.

9. The liquid crystal display of claim 8, wherein
an active area is defined as an area surrounded by the sealant,
the active area includes a corner area disposed between a corner of the active area and a corner of the display area in the plan view, and
the at least one gap is disposed in the corner area.

10. The liquid crystal display of claim 8, wherein
the gap extends toward the sealant from the corner of the display area in the plan view.

11. A liquid crystal display comprising:
a first display panel and a second display panel including a display area for displaying an image and a peripheral area surrounding the display area in a plan view;
a sealant disposed between the first display panel and the second display panel and having a shape of a closed loop surrounding the display area in the plan view;
a liquid crystal layer including liquid crystal molecules disposed between the first display panel and the second display panel; and
a protrusion disposed on the first display panel, disposed between the display area and the sealant in the plan view, and protruding toward the second display panel,
wherein the first display panel includes a first substrate,
the protrusion includes a first portion and a second portion which have upper surfaces with different heights from each other with respect to an upper surface of the first substrate,
a height of an upper surface of the first portion with respect to the upper surface of the first substrate is less than a height of an upper surface of the second portion, and
the first portion is disposed closer to the sealant than the second portion and the first portion is connected to the second portion.

12. The liquid crystal display of claim 11, wherein
the protrusion further includes a third portion disposed between the first portion and the second portion, and
a thickness of the third portion with respect to the upper surface of the first substrate gradually decreases as a distance from the sealant decreases.

13. The liquid crystal display of claim 11, wherein
an active area is defined as an area surrounded by the sealant,
the active area includes a corner area disposed between a corner of the active area and a corner of the display area facing each other in a plan view, and
the protrusion includes a portion disposed in the corner area.

14. The liquid crystal display of claim 13, wherein
the display area includes a first corner adjacent to the corner area, and two edges of the display area meet at the first corner, and
the protrusion further includes a portion disposed between one of the two edges of the display area and the sealant.

15. The liquid crystal display of claim 13, wherein
the protrusion has a shape of a closed loop disposed between an edge of the display area and the sealant.

16. The liquid crystal display of claim 11, further comprising
at least one of a light blocking layer, a color filter, or a passivation layer disposed in the display area,
wherein the passivation layer includes an organic insulating material, and
the protrusion is disposed in a same layer and includes a same material as at least one of the light blocking layer, the color filter, or the passivation layer.

17. The liquid crystal display of claim 16, wherein
the protrusion includes a first protrusion and a second protrusion,
the first protrusion overlaps the second protrusion in a vertical direction to the upper surface of the first substrate, and
a thickness of the first protrusion and a thickness of the second protrusion with respect to the upper surface of the first substrate gradually decrease as a distance from the sealant decreases.

18. A method for manufacturing a liquid crystal display comprising:
forming a first display panel and a second display panel including a display area and a peripheral area surrounding the display area;
forming a sealant on one of the first display panel and the second display panel;
dispensing a liquid crystal material including liquid crystal molecules to one of the first display panel and the second display panel;
arranging and bonding the first display panel and second display panel with each other; and
hardening the sealant,
wherein the forming of the first display panel includes forming a protrusion disposed between the display area and the sealant and protruding toward the second display panel by using a photo-mask, and
a transmittance of the photo-mask gradually increases as a distance from the sealant decreases.

19. The method of claim 18, wherein
the photo-mask includes a light blocking portion and a light transmitting portion, the light transmitting portion has a slit shape, and the light transmitting portion and the light blocking portion are alternately arranged.

20. The method of claim 19, wherein
widths of the light blocking portion and the light transmitting portion are equal to or less than a resolution of a light exposer.
